(19) United States
(12) Patent Application Publication
(10) Pub. No.: US 2014/0328510 A1
(43) Pub. Date: Nov. 6, 2014

(54) Method For Characterizing Fission Semi-Tracks in Solids

(71) Applicants: Raymond Allen Donelick, Viola, ID (US); Calvin Loncaric, Viola, ID (US); Colin O"Byrne, Viola, ID (US); Leif Gaebler, Viola, ID (US); Thea Rose Osinski, Los Angeles, CA (US); Zachary Dodds, Claremont, CA (US); Mary Rachel Stimson, Claremont, CA (US); Peter Adrien, Claremont, CA (US); Colin Bundschu, Claremont, CA (US); Elijah Omernick, Claremont, CA (US); Christopher Stone, Claremont, CA (US)

(72) Inventors: Raymond Allen Donelick, Viola, ID (US); Calvin Loncaric, Viola, ID (US); Colin O"Byrne, Viola, ID (US); Leif Gaebler, Viola, ID (US); Thea Rose Osinski, Los Angeles, CA (US); Zachary Dodds, Claremont, CA (US); Mary Rachel Stimson, Claremont, CA (US); Peter Adrien, Claremont, CA (US); Colin Bundschu, Claremont, CA (US); Elijah Omernick, Claremont, CA (US); Christopher Stone, Claremont, CA (US)

(73) Assignee: Apatite to Zircon, Inc., Viola, ID (US)

(21) Appl. No.: 13/874,480

(22) Filed: May 1, 2013

(51) Int. Cl. G06K 9/00; G01N 21/84; G01B 11/14

(52) U.S. Cl. CPC G06K 9/00624; G01B 11/14; G01N 21/84
USPC 382/103

(57) ABSTRACT

A method for determining the position and its statistical uncertainty of a fission semi-track in a crystal based on detecting the tip and etch figure of a fission semi-track in a series of transmitted light images. A computer software program for: detecting the tip and etch figure of a fission semi-track in a series of transmitted light images and assessing the viability of the tip using a scoring equation; writing to and loading from a computer database of fission semi-tracks; modifying the scoring equation for assessing fission semi-track tip viability based on the contents of the computer database. A computer database consisting of transmitted light images of fission semi-tracks. A method for determining the statistical probability that a fission semi-track is a real fission semi-track.

### BRIEF SUMMARY

This invention includes a method to determine the positions in a crystal of the tip and etch figure of a fission semi-track, comprised of: producing a series of transmitted light images; detecting the tip and etch figure of a fission semi-track; determining the positions and their statistical uncertainties of the tip and etch figure of a fission semi-track in the crystal. The method also is comprised of: accepting or rejecting as real a fission semi-track based on the statistical uncertainties of the positions of the tip and etch figure of a fission semi-track; accepting or rejecting as real a fission semi-track based on the judgment of a human being; capturing a reflected light image of the crystal surface and determining the size of one or more etch figures on the crystal surface. The prior art requires greater human labor and provides less information compared to this invention, being comprised of and limited to manually detecting each fission semi-track.

This invention includes a computer software program containing instructions to the tip and etch figure of a fission semi-track, comprised of: loading a series of transmitted light images; detecting the tip and etch figure of a fission semi-track; determining the positions and their statistical uncertainties of the tip and etch figure of a fission semi-track in the crystal; writing transmitted light images to a database; loading transmitted light images from a database. The computer software program also contains instructions comprised of: assessing the viability, using a scoring equation, of a tip of a fission semi-track; modifying the fission semi-track tip scoring equation based on the contents of a fission semi-track database; presenting to a human being for viewing by the human being a transmitted light image of the tip of a fission semi-track; calculating the statistical probability that a fission semi-track is a real fission semi-track. The prior art does not comprise the capabilities of the computer software disclosed here.

This invention includes a computer database of fission semi-tracks comprised of: allowing a fission semi-track to be inserted; allowing a fission semi-track to be removed; representing each fission semi-track in the database by one or more transmitted light images formed by the transmission of light through a crystal. The computer database also is comprised of: assigning to each inserted fission semi-track a statistical probability that the fission semi-track is a real fission semi-track; restricting the insertion of all fission semi-tracks to a human being; restricting the removal of a fission semi-track to the same human being to which insertion of fission semi-tracks is restricted. The computer database also is comprised of: restricting the insertion of all fission semi-tracks to a any member of a group of human beings; restricting the removal of a fission semi-track to any member of the same group of human beings to which insertion of fission semi-tracks is restricted. The prior art does not comprise such a database as is disclosed here.

This invention includes a method of determining the statistical probability that a fission semi-track is a real fission semi-track, comprised of: producing a series of transmitted light images; detecting the tip and etch figure of the fission semi-track; detecting the two sides of the fission semi-track; assessing the viability, using a scoring equation, of the fission semi-track tip; assessing the viability, using a scoring equation, of each fission semi-track side. The method is also comprised of: assessing the viability of the fission semi-track tip and each fission semi-track side based on the judgment of human being; assessing the viability of the fission semi-track tip and each fission semi-track side based on the collective judgment of group of human beings. The prior art allows only two, discrete values for the statistical probability that a fission semi-track is a real fission semi-track: 0 and 1. The method disclosed here allows for any value between 0 and 1, inclusive.

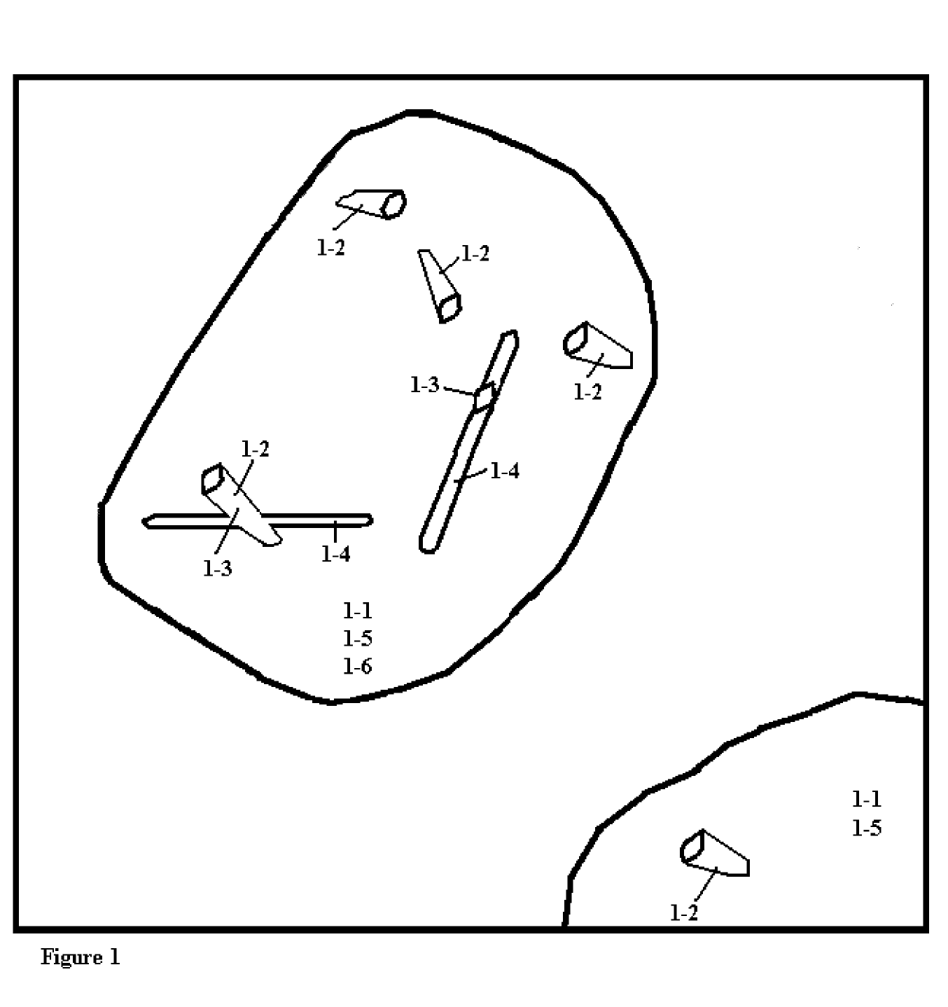

FIG. 1. Crystal mount.

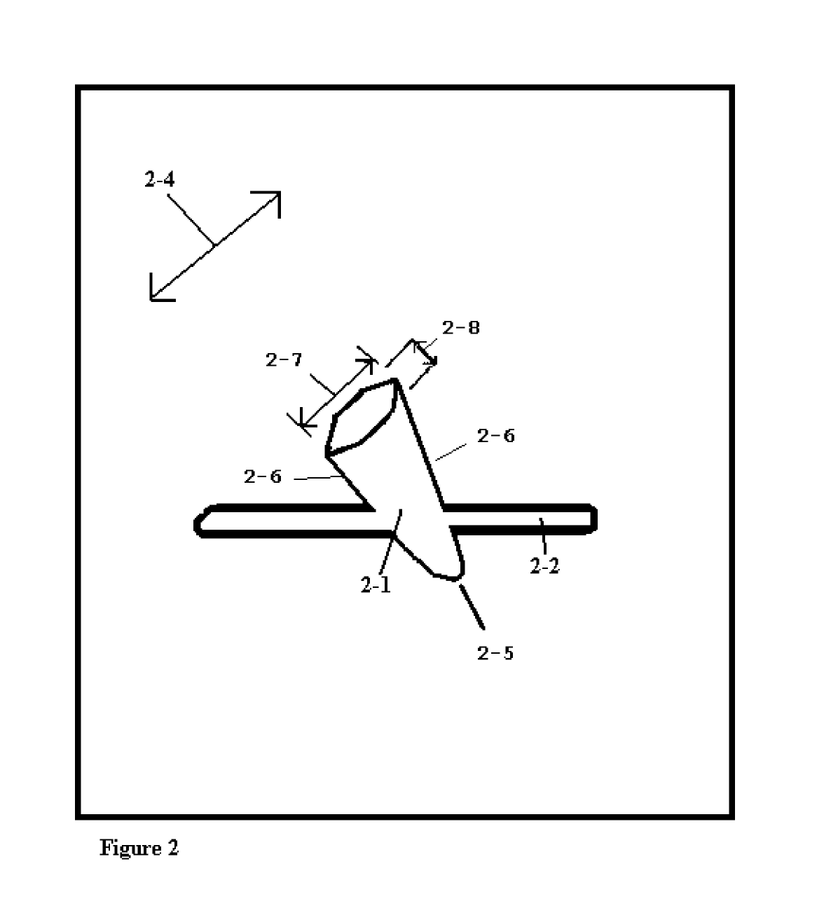

FIG. 2. Subset of crystals containing fission semi-tracks and confined fission tracks.

FIG. 3. Etch figure formed by a fission semi-track.

### A METHOD FOR CHARACTERIZING CONFINED FISSION TRACKS IN SOLIDS

### Description of the Invention

### Background

A latent fission track is a single, approximately linear, randomly oriented zone of molecular damage in a host solid resulting from the fission of a single, fissile atomic nucleus. latent fission tracks have cross-sectional diameters on the order of 10 s of Angstroms and lengths on the order of 1-20 micrometers and they are individually invisible using optical microscopy. Fissile atomic nuclei that form latent fission tracks include ²³⁵U, ²⁵²Ca, and ²³⁸U. Latent fission tracks may be created within a solid under carefully controlled laboratory conditions by the thermal-neutron-induced fission of ²³⁵U nuclei contained within the solid. In certain natural solids, such as the mineral apatite or volcanic glass, latent fission tracks form and accumulate by the spontaneous fission of ²³⁸U nuclei within the solid, some having formed shortly after the mineral crystallized or glass solidified, some having formed very recently, and some having formed during the intervening time span. Fissile ²⁵²Cf nuclei placed in proximity to a solid surface may be used to create latent fission tracks on that surface that may be used during specialized laboratory and industrial processes.

Latent fission tracks derived from the fission of ²³⁵U or ²³⁸U nuclei are randomly oriented within their host solid and exhibit a number per unit volume that correlates with the number per unit volume of parent fissile nuclei within the host solid, all other environmental factors, such as temperatures experienced by the latent fission tracks and the chemical state of the host solid, being equal. In a natural solid containing fissile ²³⁸U nuclei, latent fission tracks form throughout time due to the predictable nuclear fission of the ²³⁸U nuclei. When a natural solid is maintained at sufficiently low temperatures, new latent fission tracks accumulate and previously formed latent fission tracks experience slow, spontaneous conversion back to undamaged solid but they remain as latent fission tracks. Therefore, at sufficiently low temperatures, the number of latent fission tracks per unit volume in a natural solid correlates with both the ²³⁸U nuclei per unit volume and the duration of time over which latent fission tracks have accumulated. Knowledge of the number of latent fission tracks per unit volume and the number of ²³⁸U nuclei per unit volume in a natural solid provides the analyst a basis for age dating of the natural solid and a basis for deciphering aspects of Earth's history

The number per unit volume of latent fission tracks derived from the thermal-neutron-induced fission of ²³⁵U nuclei correlates with both the number of ²³⁵U nuclei per unit volume in the host solid and the integrated flux of thermal neutrons to which the solid was exposed. latent fission tracks derived from induced fission of ²³⁵U nuclei may be used to create and study latent fission tracks under carefully controlled laboratory conditions, and they are commonly thought to be indistinguishable upon formation from their ²³⁸U-derived counterparts due to the close similarities between the ²³⁵U and ²³⁸U nuclear fission processes.

A latent fission track must be rendered visible to enable study by a human being (herein, analyst) of its characteristics. A commonly applied process is to dissolve the latent fission track in a chemical mixture and then enlarge the resultant void space to a size visible using an optical microscope. This process is commonly referred to as etching. To accomplish etching, the solid containing latent fission tracks is polished to expose an interior plane of the solid. Some of the randomly oriented latent fission tracks may intersect this exposed interior plane. The exposed interior plane is then placed in contact with an appropriate chemical mixture. The chemical mixture dissolves any latent fission track that intersects the exposed interior plane at a greater rate than it does the surrounding undamaged solid. Following initial, relatively rapid dissolution of the latent fission track, further exposure of the undamaged solid to the chemical mixture gives rise to enlargement of the void in the undamaged solid where the latent fission track had been. Contact between the exposed interior plane of the solid and the chemical mixture is terminated when the void where the latent fission track had been is large enough to be viewed using an optical microscope.

The void space where a latent fission track had intersected the polished and etched plane of the solid penetrates into the volume of the preserved solid and is commonly referred to as a fission semi-track because part of the latent fission track had been polished away during the process of exposing the interior plane. In some instances, a fission semi-track intersects another latent fission track that is wholly confined in the preserved solid, permitting the chemical mixture to reach and preferentially dissolve the wholly confined latent fission track and enlarge its resultant void space sufficiently for optical viewing by the analyst. Such a fission semi-track that provides a pathway for the chemical mixture to reach and dissolve a wholly confined latent fission track is commonly referred to as an etchant pathway. Any wholly confined latent fission track that is reached by the chemical mixture via an etchant pathway, is preferentially dissolved and its resultant void space enlarged sufficiently for optical viewing by the analyst, and exhibits visible tips at each end of its longest axis, is commonly referred to as a confined fission track (herein, also confined fission track). The definition of etchant pathway is broadened to include any continuous combination of fission semi-tracks, confined fission tracks, cracks, disruptions or defects in the solid molecular structure, or human-induced fission semi-tracks or other zones of damage to the solid molecular structure that connect the polished and etched plane of the solid to the wholly confined latent fission track.

Fission semi-tracks and confined fission tracks may be viewed by the analyst using an optical microscope. An optical microscope transmits light through and/or reflects light off of a solid surface containing fission semi-tracks and/or confined fission tracks and modifies the light pathways so that the micrometer-sized fission semi-tracks and confined fission tracks are made visible to and distinguishable by (henceforth, visible to) the analyst. Once visible to the analyst, either directly through the optical apparatus of the microscope or indirectly using a charge coupled device affixed to the optical microscope that permits display of the visible features on a computer display screen, features of the fission semi-tracks and/or confined fission tracks of interest to the analyst are measured and documented.

The number of ²³⁵U-derived or ²³⁸U-derived fission semi-tracks per unit area of a polished and etched plane of a solid correlates with the number of latent fission tracks per unit volume of that same solid that existed before that solid was polished and etched. The number of ²⁵²Cf-derived fission semi-tracks per unit area of a treated solid surface correlates with the integrated flux of ²⁵²Cf-derived fission-fragment nuclei incident upon the surface.

The intersection between a fission semi-track and the polished and etched plane of the solid yields a well-defined geometrical shape commonly referred to as an etch figure. Etch figures exhibit characteristics, such as maximum length and width, that depend on the duration of exposure of the polished and etched plane of the solid to the chemical mixture used for etching, the temperature of the chemical mixture during etching, the composition of the chemical mixture, and the orientation of the fission semi-track relative to the polished and etched plane of the solid. Etch figures also exhibit characteristics, such as maximum length, maximum width, and symmetry or asymmetry, that depend on the nature of the polished and etched plane itself, including the chemical composition of the solid, the physical properties of the solid, and, for anisotropic solids such as anisotropic crystals, the crystal lattice plane represented by the polished and etched plane of the solid.

The ideal fission semi-track represents the etched void space left by the dissolution of a latent fission track that had intersected the polished and etched plane of the solid. The ideal fission semi-track is randomly oriented like its latent fission track precursor, and exhibits a range of possible end-to-end lengths, from very short, for the case where most of the latent fission track had been polished away, to long, for the case where a small fraction of the latent fission track had been polished away. In plan view, the ideal fission semi-track projects a complete and closed geometrical figure to the analyst when viewed using an optical microscope comprised of visible traces of the void space left by the dissolution of the latent fission track. One end of the ideal fission semi-track is composed on an etch figure and the other end is composed of the dissolved latent fission track tip trace. Between the two ends of the ideal fission semi-track are sub-parallel dissolved latent fission track side traces that connect the two ends and converge at the dissolved latent fission track tip trace.

A real fission semi-track may be comprised of a complete and closed geometrical figure visible to the analyst, having as a direct analog an ideal fission semi-track. A real fission semi-track may also have any portion of its etch figure, dissolved latent fission track tip trace, and/or dissolved latent fission track side traces rendered invisible to the analyst. Henceforth, fission semi-track refers to real fission semi-track. Part or all of the etch figure end may be rendered invisible to the analyst by overlapping, adjacent etch figures, cracks, other etched features, or other imperfections on the polished and etched plane of the solid. Latent fission track tip and side traces may be rendered partially or wholly invisible to the analyst by any combination of intersecting fission semi-tracks, confined fission tracks, cracks, disruptions or defects in the solid molecular structure, or human-induced fission semi-tracks or other zones of damage to the solid molecular structure that connect the polished and etched plane of the solid to the dissolved latent fission track traces.

When seeking to find a fission semi-track, the analyst seeks an etch figure or a part or parts thereof, an opposing dissolved latent fission track tip trace or a part or parts thereof, and/or intervening, sub-parallel dissolved latent fission track side traces or parts thereof. The analyst then attempts to envision, based on the accumulated memory of the analyst, the equivalent ideal fission semi-track for this combination of visible etch figure or a part or parts thereof, an opposing dissolved latent fission track tip trace or a part or parts thereof, and/or intervening, sub-parallel dissolved latent fission track side traces or parts thereof. If the analyst is able to positively envision an equivalent ideal fission semi-track for this combination of visible etch figure or a part or parts thereof, an opposing dissolved latent fission track tip trace or a part or parts thereof, and/or intervening, sub-parallel dissolved latent fission track side traces or parts thereof, the analyst accepts the combination of visible etch figure or a part or parts thereof, an opposing dissolved latent fission track tip trace or a part or parts thereof, and/or intervening, sub-parallel dissolved latent fission track side traces or parts thereof as a fission semi-track and adds this new fission semi-track to the accumulated memory of the analyst. The greater the fraction visible of properly positioned and oriented etch figure or a part or parts thereof, an opposing dissolved latent fission track tip trace or a part or parts thereof, and/or intervening, sub-parallel dissolved latent fission track side traces or parts thereof, the greater is the confidence of the analyst that this combination of visible etch figure or a part or parts thereof, an opposing dissolved latent fission track tip trace or a part or parts thereof, and/or intervening, sub-parallel dissolved latent fission track side traces or parts thereof is a fission semi-track. The analyst is never fully certain that these visible etch figure or a part or parts thereof, an opposing dissolved latent fission track tip trace or a part or parts thereof, and/or intervening, sub-parallel dissolved latent fission track side traces or parts thereof are, in fact, a fission semi-track and the current art does not include a means of quantifying the degree of certainty.

A confined fission track preserves characteristics of its respective dissolved latent fission track including its position and orientation within the host solid, and its approximate length. Other features of a confined fission track may be useful to the analyst including its geometrical dimensions, its inclination angle to the observational optical axis, its depth below the polished and etched solid surface, and the number, size, characteristics, and positions of other preferentially dissolved features intersecting the confined fission track including, but not limited to, other fission semi-tracks and confined fission tracks.

For a confined fission track to provide information useful to the analyst, both of its tips must be visible to the analyst. It is known from natural solids containing ²³⁸U-derived latent fission tracks that a young latent fission track yields a confined fission track exhibiting a length from tip to tip that is usually greater than the length of a confined fission track derived from a latent fission track that formed millions of years ago, all other environmental factors being equal such as temperatures experienced since formation of the latent fission tracks, and resultant confined fission track crystallographic orientation. It is also known from laboratory experiments that a latent fission track that experienced relatively high temperatures yields a confined fission track exhibiting a length that is usually less than the length of confined fission track derived from a latent fission track that experienced relatively low temperatures, all other environmental factors being equal such as latent fission track ages and crystallographic orientations. This time and temperature dependence of the lengths of confined fission tracks provides the analyst a basis for deciphering aspects of Earth's history.

In plan view, the ideal confined fission track, if it existed, would project a complete and closed geometrical figure to the analyst when viewed using an optical microscope. This closed geometrical figure would be composed of two opposing tips, with each tip exhibiting a trace visible to the analyst that is concave inward toward the other, and with the tips connected to each other by two approximately parallel and continuous visible traces of the confined fission track sides.

The ideal confined fission track is never encountered in practice because only segments of, and never all of, the real confined fission track side traces are visible to the analyst. Henceforth, confined fission track refers to any real confined fission track. Therefore, the confined fission track projects visible tip traces and partially visible side traces to the analyst, forming an incomplete, open geometrical figure similar to that envisioned by the analyst for the ideal confined fission track but with parts of the side traces invisible. This is because a confined fission track is etched via an intersecting etchant pathway. At the intersection of the etchant pathway and the confined fission track, a segment of one or each of the confined fission track side traces must be dissolved rendering the dissolved portion or portions of the side traces invisible to the analyst. The confined fission track may also intersect other preferentially dissolves features, rendering additional parts of the side traces invisible to the analyst. Dissolution of any portion of the host solid that would otherwise reveal a visible portion of a confined fission track side trace causes a portion of the confined fission track side trace to be invisible to the analyst. A portion of the confined fission track side trace may be present but rendered invisible to the analyst if it is obscured by a more prominent feature in the host solid. A portion of the confined fission track side trace may be rendered invisible to the analyst if the pathways of the light in the optical microscope do not permit the trace to be resolved by the analyst.

When seeking to find a confined fission track, the analyst seeks two visible, opposing dissolved latent fission track tip traces. The analyst then looks for two approximately parallel dissolved latent fission track side traces, or visible portions thereof, between these opposing dissolved latent fission track tip traces. The analyst then attempts to envision, based on the accumulated memory of the analyst, the equivalent ideal confined fission track for this combination of visible latent fission track tip and side traces. If the analyst is able to positively envision an equivalent ideal confined fission track for this combination of visible latent fission track tip and side traces, the analyst accepts the combination of visible latent fission track tip and side traces as a confined fission track and adds this new confined fission track to the accumulated memory of the analyst. The greater the fraction visible of properly positioned and oriented dissolved latent fission track side traces between the opposing dissolved latent fission track tip traces, the greater is the confidence of the analyst that this combination of visible latent fission track tip and side traces is a confined fission track. The analyst is never fully certain that these visible latent fission track tip and side traces are, in fact, a confined fission track and the current art does not include a means of quantifying the degree of certainty.

### Preferred Embodiment of the Invention

Fission semi-tracks and confined fission tracks are commonly studied and their characteristics documented by an experienced analyst for the purpose of deciphering aspects of Earth's history. The preferred embodiment of the invention pertains to fission semi-tracks and confined fission tracks in natural apatite crystals or crystal fragments but the current invention may be applied to other natural solids in a similar manner.

Natural apatite, a common mineral in many types of Earth rocks, often contains trace amounts of fissile ²³⁸U nuclei. Henceforth, an individual apatite crystal or apatite crystal fragment is referred to as a crystal. Crystals or crystal fragments that have been liberated from their host rock are immersed in a polymeric epoxy, the polymeric epoxy is permitted to harden, and the crystals are then cut and polished using polishing grit to expose individual interior planes of the crystals. This configuration of crystals mounted in hardened polymeric epoxy is commonly referred to as a crystal mount.

Referring to FIG. 1, after polishing, the exposed interior planes of the crystals 1-1 are etched by immersing the crystal mount in dilute HNO₃ to make visible to the analyst any natural, ²³⁸U-derived fission semi-track 1-2. Where an appropriate etchant pathway 1-3 exists to permit the dilute HNO₃ to intersect an appropriately positioned and oriented confined latent fission track a confined fission track 1-4 is made visible to the analyst. Any fission semi-tracks 1-2 and confined fission tracks 1-4 are etched using 5.5N HNO₃ for 20.0 seconds (±0.5 seconds) at 21° C. (±1° C.) in the preferred embodiment of the invention. Other etching protocols may be used. The crystal mount may be irradiated with ²⁵²Cf-derived fission fragment nuclei prior to etching if the analyst desires additional etchant pathways that include ²⁵²Cf-derived fission semi-tracks to increase the likelihood of making visible confined fission tracks. Other high-energy nuclei may be used to produce additional etchant pathways.

In the preferred embodiment of the invention, the crystal mount and the visible features it contains are viewed by the analyst using a Nikon Optiphot2 optical microscope using either transmitted light, reflected light, or a combination of transmitted and reflected light at 1562.5× magnification. The analyst may directly view the crystal mount and the visible features it contains by looking through the microscope oculars or indirectly view the crystal mount and the visible features it contains by looking at a computer display screen containing a black and white or color visualization of the crystal mount and the visible features it contains made possible using a charge coupled device affixed to the microscope and interfaced with the computer. Other optical microscopes, magnifications, and charge coupled devices may be used by the analyst to directly or indirectly view the crystal mount and the visible features it contains. In the preferred embodiment of the invention, the analyst views the crystal mount and the visible features it contains on a computer display screen as prescribed and a static visualization on the computer display screen of the crystal mount and any visible elements it contains is commonly referred to as an image.

On the crystal mount, two visible and different points are separated by a fixed distance that can be expressed in a unit of length. On the image, these same two fixed points are separated by a fixed number of computer display screen pixels. In the preferred embodiment of the invention, the image for a given combination of optical microscope model, magnification, and charge coupled device is calibrated in both the horizontal (henceforth, X) and vertical (henceforth Y) directions yielding conversion factors in units of length/pixels. These conversion factors permit the distance between any two points on the image, separated by some number of computer display screen pixels, to be expressed in a unit of length. In the preferred embodiment of the invention, the unit of length is the micrometer but other units of length may be used.

In the preferred embodiment of the invention, the optical microscope is affixed with an apparatus that obtains a record of the relative height of the crystal mount within the optical pathways of the optical microscope. This apparatus is interfaced with the same computer to which the charge coupled device is interfaced. The relative crystal mount height within the optical pathways of the optical microscope is scaled such that any change in height of the crystal mount within the optical pathways of the optical microscope may be expressed in a unit of length. In the preferred embodiment of the invention, the unit of length is the micrometer but another unit of length may be used.

In the preferred embodiment of the invention, the height of the focal plane that intersects the optical pathways of the optical microscope is fixed at a fixed magnification. A change in height of the crystal mount within the optical pathways of the optical microscope represents an identical change in height of the crystal mount relative to the focal plane.

In the preferred embodiment of the invention, crystals 1-1 on the crystal mount are pre-viewed by the analyst and a subset of the crystals 1-5 containing fission semi-tracks 1-2 of interest to the analyst is specified and a second subset of crystals 1-6 containing confined fission tracks 1-3 of interest to the analyst is specified. The fission semi-track subset of crystals 1-5 and the confined fission track subsets of crystals 1-6 may be intermixed or they may be combined into a single subset of crystals.

Referring to FIG. 2, for each crystal specified by the analyst as containing fission semi-tracks 2-1 or confined fission tracks of interest 2-2, the crystal mount is positioned so that the specified crystal is approximately centered within the image on the computer display screen. The initial height of the crystal mount within the optical pathways of the optical microscope set so that the polished and etched plane of the host crystal containing the fission semi-track 2-1 or confined fission track 2-2 is at the height equal to the focal plane of the optical pathways of the optical microscope. In the preferred embodiment of the invention, the positioning of the initial height of the crystal mount is done using reflected light. Transmitted light with or without reflected light may be used for the initial height positioning. Reflected light is turned off and transmitted light is turned on and lighting is adjusted as needed by the analyst. The crystal mount is moved so that the focal plane is 1.0 micrometers away from the polished and etched plane of the host crystal and outside of the preserved volume of the host crystal. The data and/or signal transmitted by the charge coupled device to the computer required to present an image on the computer display screen are recorded for this grain mount position, a process henceforth referred to as recording an image. The crystal mount is then moved, in a series of 0.5 micrometer steps, so that the focal plane of the optical pathways of the optical microscope is moved toward the interior of the preserved volume of the host crystal. Each step represents a new position of the crystal mount within the optical pathways of the optical microscope and the image for each position is recorded. This process is ended when the focal plan is positioned 20.0 micrometers away from the polished and etched plane of the host crystal and within the preserved volume of the host crystal. Each recorded image is associated with a position (henceforth Z) relative to the polished and etched plane of the host crystal. Images recorded with the focal plane located outside the preserved crystal are associated with negative Z values, the absolute value of Z equal to the distance between the focal plane and the polished and etched crystal surface. Images recorded with the focal plane located inside the preserved volume of the host crystal are associated with positive Z values equal to the distance between the focal plane and the polished and etched crystal surface. Another starting distance, other than 1.0 micrometers, of the focal plane away from the polished and etched plane of the host crystal, may be used. Other step-wise movements, other than a fixed 0.5 micrometers, may separate adjacent positions of the polished and etched plane of the host crystal. Another ending distance, other than 20.0 micrometers, of the focal plane away from the polished and etched plane of the host crystal, may be used.

For each crystal specified by the analyst as containing fission semi-tracks 2-1 or confined fission tracks 2-2 of interest, the crystal mount is positioned so that the specified crystal is approximately centered within the image on the computer display screen. The crystal mount is then positioned so that the polished and etched plane of the host crystal containing the fission semi-track 2-1 or confined fission track 2-2 is at the height equal to the focal plane of the optical pathways of the optical microscope. In the preferred embodiment of the invention, this positioning of the crystal mount is done using reflected light. Transmitted light with or without reflected light may be used for this positioning. Transmitted light, if on, is turned off, reflected light is turned on, and lighting is adjusted as needed by the analyst. The crystal mount is moved so that the focal plane is 1.0 micrometers away from the polished and etched plane of the host crystal and outside of the preserved volume of the host crystal. The image is recorded for this grain mount position. The crystal mount is then moved, in a series of 0.5 micrometer steps, so that the focal plane of the optical pathways of the optical microscope is moved toward the interior of the preserved volume of the host crystal. At each step, the image is recorded for the grain mount position. This process is ended when the focal plan is positioned 20.0 micrometers away from the polished and etched plane of the host crystal and within the preserved volume of the host crystal. Another starting distance, other than 1.0 micrometers, of the focal plane away from the polished and etched plane of the host crystal, may be used. Other step-wise movements, other than a fixed 0.5 micrometers, may separate adjacent positions of the polished and etched plane of the host crystal. Another ending distance, other than 20.0 micrometers, of the focal plane away from the polished and etched plane of the host crystal, may be used.

In the preferred embodiment of the invention, the subset of crystals specified by the analyst for study of its fission semi-tracks is subjected to the prescribed processes of transmitted light image recording and reflected light image recording separately from the subset of crystals specified by the analyst for study of its confined fission tracks. Images are recorded for transmitted light followed by the recording of images for reflected light. It is possible to mix specified fission semi-track and confined fission track grains during image recording and it is possible to record images for transmitted light, then for reflected light, while at each specified crystal.

The transmitted light recorded images and reflected light recorded images for each of these crystal mount positions may contain one or more fission semi-track 2-1, one or more confined fission track 2-2, and any other feature of interest to the analyst including one or more of the following: etch figures, etched or un-etched fluid and/or mineral inclusions, etched cracks, etched disruptions or defects in the apatite crystal structure, and any part of an etchant pathway.

In the preferred embodiment of the invention, each pixel of the transmitted light recorded images and the reflected light recorded images is converted to its equivalent color on the gray scale with color ranging from black to white. The equivalent color is then converted to a number, black set equal to zero, white set equal to 255, and a color between black and white set equal to a value appropriate to the position of the color between black and white. Brightness refers to this gray scale number with a higher number having greater brightness. A visible feature in these images is defined by a brightness difference between adjacent pixels, a brightness gradient among pixels in a given direction, and/or a brightness curvature which is the rate of change of the brightness gradient among pixels in a given direction. The pixel information from the transmitted light and reflected light recorded images, including the original color, may be converted to different equivalent colors and/or different numerical values, and brightness may be defined in a different mathematical sense and other commonly used image processing concepts such as contrast may be used.

In the preferred embodiment of the invention, detecting and characterizing a particular visible feature requires limits to be set on the search area size over which a particular feature is sought for two dimensional features such as an etch FIG. 2-3, or the search volume size for three-dimensional features such as fission semi-tracks 2-1 and confined fission tracks 2-2. Once the search area or search volume size limits are set, a scheme is employed to move the search area through an image or the search volume through a series of images and execute the required test, specific to the particular type of feature sought, at each position of the search area or search volume. When results of the required test indicate the possible presence of a particular visible feature of interest, limits on the X and Y dimensions of the fitting window are generally set equal to three times the maximum dimension of the feature sought in its maximum state. The fitting window defines the area, in two dimensions, or volume when passed through adjacent images having different Z values, in which the mathematical procedures are executed to find and characterize the feature of interest. The mathematical procedures themselves involve the use of either public-domain, commercially available, or custom equations and/or computer algorithms. These equations and/or algorithms are generally designed to calculate the mathematical equation, such as a line or ellipse, that best fits a series of pixel X,Y coordinates, pixels defined by brightness differences between adjacent pixels, brightness gradients among pixels in a given direction, and/or brightness curvatures among pixels in a given direction. Limits are set on the length along the fitted equation, where appropriate, and width about the fitted equation imposed during execution of the equation fitting process and these limits may depend on the nature of the feature to which the equation fitting process pertains and/or pixel brightness characteristics within the fitting window and/or over the whole image. Other fitting window sizes and fitting equation length and width limits may be used. Other means of characterizing brightness variations over an image or series of images may be used as a basis for constraining the fitting equation length and width limits.

Each crystal possesses grain-wide characteristics that may be associated with all fission semi-tracks 2-1 and confined fission tracks 2-2 it may yield, including but not limited the equation of a line in X,Y,Z space that is parallel to the crystallographic c-axis of the crystal 2-4. It is common practice for the analyst to consider only crystals for which the crystallographic c-axis is parallel to or nearly parallel to the polished and etched crystal surface on the crystal mount. Etch FIGS. 2-3 visible in a transmitted or reflected recorded image of a crystal surface etched in 5.5N HNO₃ for 20.0 seconds (±0.5 seconds) at 21° C. (±1° C.) are elongate in the direction of the crystallographic c-axis 2-4 and parallel or nearly parallel to one another if the c-axis direction 2-4 is parallel to or nearly parallel to the polished and etched plane of the crystal. Nearly parallel is commonly viewed to indicate within 10 degrees but another definition of nearly parallel may be used. Referring to FIG. 3, etch FIGS. 3-1 for fission semi-tracks 3-2 for a single crystal exhibit maximum diameters (henceforth, Dpar values) 3-3 parallel to the direction of the crystallographic c-axis 3-4 and minimum diameters (henceforth, Dper values) 3-5 perpendicular to the direction of the crystallographic c-axis 3-4. Etch FIGS. 3-1 are identified in the transmitted light or reflected light image for which Z equals zero by passing the search area over the image and finding closed geometrical figures made visible by differences in brightness. Ellipses are fitted to these closed geometrical figures and a histogram of the major axes of all fitted ellipses may be plotted. Generally, the histogram peak exhibiting the smallest mean value is composed of Dpar values 3-3 for fission semi-tracks 3-2 and other etched features such as some types of crystallographic lattice imperfections that yield etch figure dimensions similar to etch FIGS. 3-1 from fission semi-tracks 3-2. The mean Dpar 3-3 value and its standard deviation for the crystal are set equal to the mean and standard deviation of the individual Dpar 3-3 values that contribute to the histogram peak exhibiting the smallest mean value. The mean Dper 3-5 value and its standard deviation for the crystal are set equal to the mean and standard deviation of the Dper 3-5 values that are associated with the Dpar 3-3 values used to calculate the mean Dpar 3-3 value and its standard deviation for the crystal. The analyst may be presented with the option to accept or reject any or all individual Dpar 3-3 and Dper 3-5 values that are used to calculate the mean Dpar 3-3 value and its standard deviation and mean Dper 3-5 and its standard deviation for the crystal. Other geometrical figures may be fitted to the etch FIGS. 3-1 including polygons such as a rectangle or hexagon and other statistical measures may be used as estimates of the Dpar 3-3 and Dper 3-5 values for the crystal including median or mode.

The major axes of the ellipses fitted to the etch FIGS. 3-1 for the crystal should be largely parallel to each other if the direction of the crystallographic c-axis 3-4 of the crystal is parallel or nearly parallel to the polished and etched plane of the crystal. In the preferred embodiment of the invention, each fitted ellipse major axis may be either parallel to the Y-axis of the recorded image or it exhibits an acute or right angle at its intersection with the Y-axis. The offset of the crystallographic c-axis of the crystal relative to the Y-axis is taken as the median angle of these fitted ellipse major axis offset angles. The standard deviation of the estimate of the offset of the crystallographic c-axis is taken as the standard deviation of the individual fitted ellipse major axis offset angles about the median offset angle value. The analyst may be presented with the option to accept or reject any or all individual fitted ellipse major axis offset angles used to calculate the offset angle of the crystallographic c-axis of the crystal from the Y-axis of the recorded image. Other statistical measures may be used to estimate the offset angle of the crystallographic c-axis of the crystal from the Y-axis of the recorded image including the mean or mode.

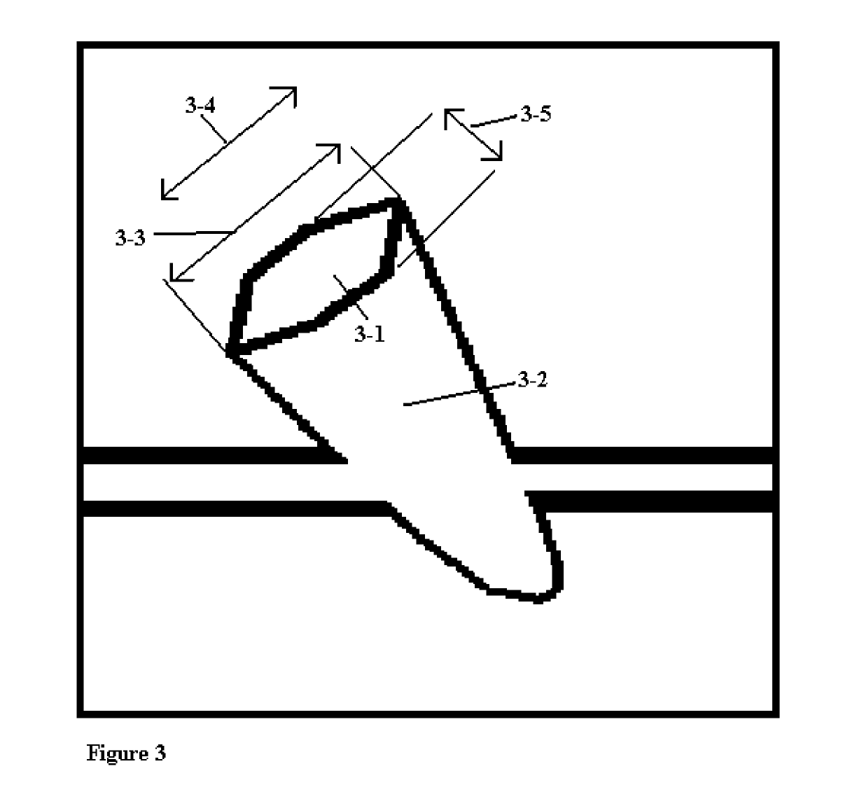

The etch figures found and used to determine the crystal Dpar 3-3 and Dper 3-5 values are used to search for and identify any potential fission semi-track 3-2 for the crystal. Referring to FIG. 2, although the etch FIG. 2-3 for a fission semi-track 2-1 may be partly or completely invisible to the analyst due to overlap by an adjacent etch figure or adjacent etch figures, a fission semi-track 2-1 in the preferred embodiment of the invention is required to present to the analyst at least a part of a visible etch FIG. 2-3. In the preferred embodiment of the invention, the Dpar 2-8 value and its uncertainty and the Dpar value and its uncertainty for the etch figure is determined as prescribed above. A search volume presenting a circular area of 20.0 microns diameter centered on the etch FIG. 2-3 is passed through the transmitted light images from Z equals zero to Z equals 20.0 microns. The required test involves seeking an etched latent fission track tip trace 2-5, characterized by a pattern of brightness variations among pixels within a 5.0 micron search sphere that exhibit approximately parabolic shape. When such an etched latent fission track tip 2-5 is found, a parabola is fitted to a subset of the pixels that exhibit approximately parabolic shape, the subset being those pixels that define the steepest brightness gradients in both the X and Y directions. The fitted parabola is defined by three fitted coefficients. The three fitted coefficients are used to calculate the X, Y, Z position of the vertex of the parabola and this position is equated to the position of the end of the etched latent fission track tip. The three fitted coefficients are used to calculate the line containing the axis of the parabola. If the fitted parabola opens toward the etch FIG. 2-3 and the line containing the parabola axis passes near the etch FIG. 2-3, the etched latent fission track tip 2-5 and associated etch FIG. 2-3 are deemed opposing and combined are considered a potential fission semi-track 2-1 with a potential fission semi-track tip 2-5 and associated etch FIG. 2-3. Evidence of visible side traces 2-6 of an etched latent fission track between the potential fission semi-track tip 2-5 and its associated etch FIG. 2-3 is sought. The search area for the second test is defined as a quadrilateral area twice as wide as the crystal Dpar 2-7 value, centered on and including the line segments connecting the potential fission semi-track tip 2-5 to each of the two ends of the major axis of the ellipse fitted to the associated etch FIG. 2-3, and including the whole associated etch FIG. 2-3. The second test involves searching for and fitting line segments to any found linear patterns of brightness variations among pixels within the search area. Any line segments within 10 degrees offset orientation from the line segments connecting the potential fission semi-track tip 2-5 to either of the two ends of the major axis of the ellipse fitted to the associated etch FIG. 2-3 are considered possible etched latent fission track side traces 2-6 that connect the potential fission semi-track tip 2-5 to the associated etch FIG. 2-3. The greater the degree of connection among the possible latent fission track side traces 2-6 to each other and to the potential fission semi-track tip 2-5 and associated etch FIG. 2-5, the greater the likelihood that these traces combined represent a fission semi-track 2-1. The results of these tests may be presented to the analyst and the analyst may decide whether or not the associated etch FIG. 2-3 and the potential fission semi-track tip 2-5 and side traces 2-6 represent a fission semi-track 2-1 as envisioned by the analyst for an equivalent ideal fission semi-track and if the decision is affirmative, the images of the fission semi-track are added to the database of fission semi-tracks (henceforth, fission semi-track database) that is stored in a data storage device.

It is possible that a fission semi-track 2-1 may not exhibit a well defined fission semi-track tip 2-5 because the fission semi-track tip 2-5 may be below the etch FIG. 2-5 and invisible to the analyst or it may be invisible to the analyst due to any combination of intersecting fission semi-tracks 2-1, confined fission tracks 2-2, cracks, disruptions or defects in the solid molecular structure, or human-induced fission semi-tracks or other zones of damage to the solid molecular structure that connect the polished and etched interior plane of the solid to the fission semi-track 2-1. Each etch FIG. 2-3 used to determine the crystal Dpar 2-8 3-3 and Dper 3-5 values is characterized and scored by the fission semi-track scoring algorithm and presented to the analyst as a potential fission semi-track 2-1. Each partial etch figure having similar Dpar and/or Dper values to the etch FIGS. 2-3 3-1 used to determine the crystal Dpar 2-8 3-3 and Dper 3-5 values is characterized and scored by the fission semi-track scoring algorithm and presented to the analyst as a potential fission semi-track 2-1.

The greater the number of fission semi-tracks 2-1 in the fission semi-track database, the greater is the accumulated experience available to the computer program from which the fission semi-track scoring algorithm may be developed and refined and to which new potential fission semi-tracks 2-1 may be compared. In the preferred embodiment of the invention, a fission semi-track scoring algorithm is available which seeks to estimate the relative likelihood that a combination of characterized etch FIG. 2-3 and potential fission semi-track tip 2-5 and side traces 2-6 would be decided in the affirmative to be a fission semi-track by the analyst. The fission semi-track scoring algorithm utilizes all available information concerning the potential fission semi-track. This information includes the Dpar 3-3 and Dper 3-5 values for the host crystal, the Dpar 2-8 and Dper 2-9 values for the potential fission semi-track, the length and its uncertainty of the potential fission semi-track 2-1, defined as the distance and its uncertainty between potential fission semi-track tip trace 2-5 and the mid-point of the major axis of the ellipse fitted to its etch FIG. 2-3, the angle and its uncertainty of the potential fission semi-track axis, defined as the line segment connecting the potential fission semi-track tip trace 2-5 and the mid-point of the major axis of the ellipse fitted to its etch FIG. 2-3, to the direction of the crystallographic c-axis 2-4, the inclination angle of the potential fission semi-track axis to the polished and etched interior plane of the crystal, the depth of the potential fission semi-track tip trace 2-5 below the polished and etched interior plane of the crystal, the degree to which geometrical figure formed by the potential fission semi-track etch FIG. 2-3, tip 2-5 and side traces 2-6 resembles the closed figure likely to be envisioned by the analyst for its equivalent ideal fission semi-track, the degree of smoothness of the potential fission semi-track side traces 2-6, and the number and type of intersecting etched features. The weighting of this information in the fission semi-track scoring algorithm varies with the type of information. Potential fission semi-track 2-1 length, potential fission semi-track axis angle to the direction of the crystallographic c-axis 2-4, potential fission semi-track Dpar 2-8 and Dper 2-9 values, and the degree to which the potential fission semi-track etch FIG. 2-3 and tip 2-5 and side traces 2-6 represent the closed geometrical figure of an ideal fission semi-track are of greatest importance. The algorithm, including how it weighs each bit of information, is periodically updated as new images of fission semi-tracks 2-1 are added to the fission semi-track database. A fission semi-track database containing images of tens of thousands fission semi-tracks 2-1, combined with an experience-based fission semi-track scoring algorithm that is optimized to provide the highest overall score to the stored fission semi-tracks is likely to reach a condition where a potential fission semi-track 2-1 having a score above some score threshold is 99 percent likely, or some other percentage of interest to the analyst, to be decided in the affirmative by the analyst to be a fission semi-track 2-1. At some point, the analyst may become sufficiently confident in the fission semi-track database and associated fission semi-track scoring algorithm to accept as a fission semi-track a potential fission semi-track 2-1 having a score above some threshold.

In the preferred embodiment of the invention, the fission semi-track scoring algorithm may present to the analyst an estimate of probability that a potential fission semi-track is a fission semi-track. This probability may include an assessment of the overall distribution of potential fission semi-track lengths and orientations relative to a theoretical prediction or a similar number of ideal fission semi-tracks with the purpose being to identify potential fission semi-tracks exhibiting characteristics such as a preferred orientation or preferred length that is highly unlikely for the theoretical ideal fission semi-tracks. The computer program containing the fission semi-track scoring algorithm presents to the analyst the ability to accept this estimate of probability or override this estimate with a value specified by the analyst.

In the preferred embodiment of the invention, the fission semi-track database is searchable. Search indices may be comprised of the identity of the analyst who decided to add the images of the fission semi-track 2-1 to the fission semi-track database, Z value of each image, the probability that the fission semi-track images are actually for a fission semi-track, the Dpar 2-8 and Dper 2-9 values of the associated etch FIG. 2-3 of the fission semi-track 2-1, fission semi-track length, fission semi-track angle to the direction of the crystallographic c-axis 2-4, fission semi-track inclination angle to the polished and etched interior plane of the crystal, fission semi-track tip 2-5 depth below the polished and etched interior plane of the crystal, the degree to which geometrical figure formed by the potential fission semi-track etch FIG. 2-3 and tip 2-5 and side traces 2-6 resembles the closed figure likely to be envisioned by the analyst for its equivalent ideal fission semi-track, the degree of smoothness of the fission semi-track side traces 2-6, and the number and type of intersecting etched features. If new or revised methods of evaluating these parameters or others are developed and/or as the fission semi-track scoring algorithm is developed and refined, fission semi-track images may be reprocessed through the new methods and/or new fission semi-track scoring algorithm and the filenames may be changed to reflect the new information.

In the preferred embodiment of the invention, the fission semi-track database is specific to the identity of the analyst that made the decision to add each set of images of a fission semi-track 2-1 to the fission semi-track database. Each set of images of a fission semi-track 2-1 in the fission semi-track database is transferable to an analyst having a different identity on the condition that there is consensus between the two analysts that the images represent a fission semi-track.

In the preferred embodiment of the invention, new potential fission semi-tracks 2-1 may be scored against a fission semi-track database where two or more analysts agree by consensus that each set of fission semi-track images in the database represents a fission semi-track 2-1. A consensus group is composed of two or more analysts contributing to a fission semi-track database containing images of fission semi-tracks agreed to by consensus.

In the preferred embodiment of the invention, fission semi-tracks 2-1 may be sorted according to any of the available types of information including but not limited to analyst identity or consensus group, the probability a fission semi-track is actually a fission semi-track, and the overall score produced by the fission semi-track scoring algorithm. A subset of the fission semi-tracks meeting specified sorting criteria applied to the available types of information and/or specified scoring criteria may be selected for purposes of deciphering aspects of Earth's history.

In the preferred embodiment of the invention, a computer program is made available to the analyst to aid the analyst with the decision whether a potential fission semi-track is an actual fission semi-track. This program presents to the analyst images of the potential fission semi-track on a computer display screen and allows the recall of images from the fission semi-track database. Images of the potential fission semi-track may be presented on the computer display screen simultaneously with recalled images of a fission semi-track from the fission semi-track database or they may be displayed separately or at different times at the choosing of the analyst. Images of the potential fission semi-track and recalled fission semi-track from the fission semi-track database are presented to the analyst with crystallographic orientation normalized whereby the crystallographic c-axis directions for the associated images are aligned in the Y direction of the computer display screen. Images of the potential fission semi-track and recalled fission semi-track from the fission semi-track database are presented to the analyst with fission semi-track position normalized whereby the mid-points of the potential fission semi-track and recalled fission semi-track axes are placed at the center of the image displayed on the computer display screen. Images of the potential fission semi-track and recalled fission semi-track from the fission semi-track database are presented with X and Y direction length scales normalized whereby they present to the analyst the same X and Y direction length scales for the associated images. Other means of normalizing images of the potential fission semi-track and recalled fission semi-track from the fission semi-track database may be used. The computer program presents to the user the option of viewing a series of fission semi-track images from the fission semi-track database whereby the series is defined by specified sorting criteria applied to the available types of information and/or specified scoring criteria. The computer program presents to the analyst the option of parsing through the series of fission semi-track images from the fission semi-track database and the option to modify the specified sorting criteria applied to the available types of information and/or specified scoring criteria defining the series of fission semi-track images. This ability to compare images of a potential fission semi-track to images of recalled fission semi-tracks from the fission semi-track database provide a basis for an experienced analyst to train an inexperienced analyst.

In the preferred embodiment of the invention, available information for a fission semi-track includes various uncertainty values including but not limited to the probability that the fission semi-track is actually a fission semi-track and the uncertainties on fission semi-track length and fission semi-track axis offset angle from the crystallographic c-axis. Other uncertainties include grain-scale values such as the uncertainties of crystal Dpar and Dper values. These uncertainties may be passed on to any method of interpretation that utilizes the fission semi-track for purposes of deciphering aspects of Earth's history. Uncertainties may be passed to the method of interpretation using standard statistical protocols and/or they may be passed to the method of interpretation using numerical methods such as a Monte Carlo simulation. As the fission semi-track database becomes larger and the fission semi-track scoring algorithm is developed further and refined, the understanding of these uncertainties by the analyst will increase and the means of passing them to the method of interpretation will improve and the ultimate result is that the means of deciphering aspects of Earth's history that utilizes the fission semi-track will improve.

1. A method of determining the position of the tip of a fission semi-track in a crystal comprising the steps of: capturing light transmitted through the crystal when the focal plane is at each of a series of known positions to produce a series of transmitted light images; detecting the tip of the fission semi-track; determining the position in the crystal of the tip of the fission semi-track.

2. A method as defined in claim 1 wherein the step of capturing light transmitted through the crystal to produce a series of transmitted light images includes the steps: imaging a plane containing the tip of the fission semi-track; imaging a plane containing the etch figure of the fission semi-track.

3. A method as defined in claim 2 wherein the step of imaging a plane containing the tip of a fission semi-track includes the steps: determining transmitted light brightness gradient values from the transmitted light images and near the tip of the fission semi-track; detecting the tip of the fission semi-track based on the transmitted light brightness gradient values; fitting a mathematical equation to a series of transmitted light gradient values from the transmitted light images and near the tip of the fission semi-track.

4. A method as defined in claim 3 wherein the step of fitting a mathematical equation to a series of transmitted light brightness gradient values from the transmitted light images and near the tip of a fission semi-track includes the steps: determining the statistical uncertainty of the mathematical equation fitted to the series of transmitted light brightness gradient values from the transmitted light images and near the tip of the fission semi-track; accepting or rejecting as being real the tip of the fission semi-track based on the statistical uncertainty of the mathematical equation fitted to the series of transmitted light brightness gradient values from the transmitted light images and near the tip of the fission semi-track.

5. A method as defined in claim 4 also comprising the step of accepting or rejecting as being real the tip of the fission semi-track based on the judgment of a human being.

6. A method as defined in claim 3 also comprised of the steps: calculating the respective position in the crystal of the tip of a fission semi-track from the respective fitted mathematical equation for the tip of the fission semi-track; calculating the statistical uncertainty of the position in the crystal of the tip of the fission semi-track from the statistical uncertainty of the fitted mathematical equation for the tip of the fission semi-track.

7. A method as defined in claim 1 also comprising the steps: capturing light reflected from the crystal when the focal plane contains the polished and etched crystal surface to produce a reflected light image; determining reflected light brightness gradient values from the reflected light image and near an etch figure; fitting a mathematical equation to a series of reflected light gradient values from the reflected light image and near an etch figure; determining the statistical uncertainty of the mathematical equation fitted to a series of reflected light gradient values from the reflected light image and near an etch figure; determining the size of an etch figure in the reflected light image.

8. A computer software program for detecting a fission semi-track in a crystal comprising instructions for: loading a series of transmitted light images formed by the transmission of light through a crystal; detecting the tip of a fission semi-track from the transmitted light brightness gradient values from the transmitted light images; writing transmitted light images to a computer database; loading transmitted light images from a computer database.

9. A computer software program as defined in claim 8 and also comprising instructions for: fitting a mathematical equation to a series of transmitted light brightness gradient values from the series of transmitted light images and near the tip of a fission semi-track; assessing the viability, using a scoring equation, of the tip of a fission semi-track based on the statistical uncertainty of the mathematical equation fitted to a series of transmitted light brightness gradient values from the series of transmitted light images and near the tip of a fission semi-track.

10. A computer software program as defined in claim 8 wherein writing transmitted light images to a computer database and loading transmitted light images from a computer database also comprises instructions for: writing a transmitted light image containing the tip of a fission semi-track; loading one transmitted light image containing the tip of a fission semi-track; loading two or more transmitted light images, each transmitted light image containing the tip of a fission semi-track.

11. A computer software program as defined in claim 10 wherein loading two or more transmitted light images, each transmitted light image containing a tip of a fission semi-track also includes instructions for: modifying the scoring equation for assessing the viability of a tip of a fission semi-track.

12. A computer software program as defined in claim 8 and also comprising instructions for presenting to a human being for viewing by the human being a transmitted light image of the tip of a fission semi-track.

13. A computer software program as defined in claim 8 and also comprising instructions for calculating the statistical probability that a fission semi-track is a real fission semi-track.

14. A computer database of fission semi-tracks comprised of: allowing a fission semi-track to be inserted; allowing a fission semi-track to be removed; representing each fission semi-track in the database by one or more transmitted light images formed by the transmission of light through a crystal.

15. A computer database of fission semi-tracks as defined in claim 14 and also comprised of assigning to each inserted fission semi-track a statistical probability that the fission semi-track is a real fission semi-track.

16. A computer database of fission semi-tracks as defined in claim 14 and also comprised of: restricting the insertion into the database of all fission semi-tracks to a human being; restricting the removal from the database of a fission semi-track to the same human being to which insertion of fission semi-track is restricted.

17. A computer database of fission semi-tracks as defined in claim 14 and also comprised of: restricting the insertion into the database of all fission semi-tracks to a any member of a group of human beings; restricting the removal from the database of a fission semi-track to any member of the same group of human beings to which insertion of fission semi-tracks is restricted.

18. A method of determining the statistical probability that a fission semi-track is a real fission semi-track, comprised of: capturing light transmitted through the crystal when the focal plane is at each of a series of known positions to produce a series of transmitted light images; detecting the tip of the fission semi-track; detecting the two sides of the fission semi-track; assessing the viability of the tip of the fission semi-track; assessing the viability of each fission semi-track side.

19. A method of determining the statistical probability that a fission semi-track is a real fission semi-track as defined in claim 18 also comprising the steps of: assessing the viability, using a scoring equation, of the tip of a fission semi-track based on the statistical uncertainty of the mathematical equation fitted to a series of transmitted light brightness gradient values from the series of transmitted light images and near the tip of a fission semi-track; assessing the viability, using a scoring equation, of a side of a fission semi-track based on the statistical uncertainty of the mathematical equation fitted to a series of transmitted light brightness gradient values from the series of transmitted light images and near a side of a fission semi-track.

20. A method of determining the statistical probability that a fission semi-track is a real fission semi-track as defined in claim 18 also comprising the steps of: assessing the viability of the tip of a fission semi-track based on the judgment of a human being; assessing the viability of each fission semi-track side based on the judgment of a human being.

21. A method of determining the statistical probability that a fission semi-track is a real fission semi-track as defined in claim 18 also comprising the steps of: assessing the viability of the tip of a fission semi-track based on the collective judgment of a group of human beings; assessing the viability of each fission semi-track side based on the collective judgment of a group of human beings.
